(19) United States
(12) Patent Application Publication
(10) Pub. No.: US 2016/0172706 A1
(43) Pub. Date: Jun. 16, 2016

(54) ELECTROLYTE AND ELECTRODE STRUCTURE

(71) Applicant: GM GLOBAL TECHNOLOGY OPERATIONS LLC, Detroit, MI (US)

(72) Inventors: Qiangfeng Xiao, Troy, MI (US); Mei Cai, Bloomfield Hills, MI (US); James R. Salvador, Royal Oak, MI (US); Li Yang, Troy, MI (US); Fang Dai, Sterling Heights, MI (US)

(21) Appl. No.: 14/815,277

(22) Filed: Jul. 31, 2015

Related U.S. Application Data
(60) Provisional application No. 62/090,200, filed on Dec. 10, 2014.

(51) Int. Cl. H01M 10/056; H01M 10/0568; H01M 10/0569; H01M 4/40; H01M 10/0564; H01M 4/38; H01M 4/583; H01M 10/0525; H01M 10/0562

(52) U.S. Cl. CPC H01M 10/056; H01M 10/0525; H01M 10/0568; H01M 10/0569; H01M 10/0562; H01M 10/0564; H01M 4/382; H01M 4/386; H01M 4/583; H01M 4/387; H01M 4/405; H01M 2220/10; H01M 2220/30; H01M 2220/20; H01M 2300/0025; H01M 2300/0068

(57) ABSTRACT

An example electrolyte includes a solvent, a lithium salt, and a solvent-soluble film precursor. The solvent-soluble film precursor is selected from the group consisting of (Li₂S)₁—(P₂S₅)ₘ—(YX₂)ₙ, wherein each of 1, m and n≧0 but at least two of 1, m, or n is >0, Y is at least one element selected from the group consisting of Ge, Si, and Sn, and X is at least one element selected from the group consisting of S, Se, and Te.

### CROSS-REFERENCE TO RELATED APPLICATIONS

This application claims the benefit of U.S. Provisional Patent Application Ser. No. 62/090,200, filed Dec. 10, 2014, which is incorporated by reference herein in its entirety.

### BACKGROUND

Secondary, or rechargeable, lithium batteries are often used in many stationary and portable devices, such as those encountered in the consumer electronic, automobile, and aerospace industries. The lithium class of batteries has gained popularity for various reasons, including a relatively high energy density, a general nonappearance of any memory effect when compared to other kinds of rechargeable batteries, a relatively low internal resistance, and a low self-discharge rate when not in use. The ability of lithium batteries to undergo repeated power cycling over their useful lifetimes makes them an attractive and dependable power source.

### SUMMARY

An example electrolyte includes a solvent, a lithium salt, and a solvent-soluble film precursor. The solvent-soluble film precursor is selected from the group consisting of (Li₂S)₁—(P₂S₅)ₘ—(YX₂)ₙ wherein each of 1, m and n≧0 but at least two of 1, m, or n is >0, Y is at least one element selected from the group consisting of Ge, Si, and Sn, and X is at least one element selected from the group consisting of S, Se, and Te.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a cross-sectional, schematic view of a lithium conductive solid electrolyte interface (SEI) layer formed on a surface of a negative electrode;

FIG. 2 is a cross-sectional, schematic view of a lithium sulfur battery that has an SEI layer formed on a surface the negative electrode;

FIG. 3 is a cross-sectional, schematic view of a lithium metal battery that has an SEI layer formed on a surface of each of the negative electrode and positive electrode;

FIG. 4 is a graph illustrating the Coulombic efficiency of a comparative example cell and two different example cells including different electrolytes disclosed herein;

FIG. 5 is a graph illustrating the capacity retention (left Y axis) and the Coulombic efficiency (right Y axis) of a comparative example battery and two different example batteries including different electrolytes disclosed herein; and

FIGS. 6A-6D, on coordinates of Intensity I (in arbitrary units) and Binding Energy BE (in Kev), show plots of results taken with X-ray photoelectron spectroscopy of the SEI, in which FIGS. 6A and 6C are for the F 1s electron and the Li 1s electron, respectively, FIGS. 6B and 6D are for the C 1s electron and S 1s electron respectively, FIGS. 6A-6B are for the positive electrode, and FIGS. 6C-6D are for the negative electrode.

### DETAILED DESCRIPTION

Lithium-based batteries generally operate by reversibly passing lithium ions between a negative electrode (sometimes called an anode) and a positive electrode (sometimes called a cathode). The negative and positive electrodes are situated on opposite sides of a porous polymer separator soaked with an electrolyte solution that is suitable for conducting the lithium ions. During charging, lithium ions are inserted (e.g., intercalated, alloyed, etc.) into the negative electrode, and during discharging, lithium ions are extracted from the negative electrode. Each of the electrodes is also associated with respective current collectors, which are connected by an interruptible external circuit that allows an electric current to pass between the negative and positive electrodes. Examples of lithium-based batteries include a lithium sulfur battery (i.e., includes a sulfur based positive electrode paired with a lithium or lithiated negative electrode), a lithium ion battery (i.e., includes a lithium based positive electrode paired with a negative electrode or a non-lithium positive electrode paired with a lithium or lithiated negative electrode), and a lithium metal battery (i.e., includes lithium based positive and negative electrodes).

Examples of the negative electrode or both the negative electrode and positive electrode disclosed herein have a lithium conductive solid electrolyte interphase (SEI) layer formed on a surface thereof. The lithium ion conductivity of the SEI layer is relatively high, e.g., at least 10⁻⁴ siemens per centimeter (S/cm).

The lithium conductive SEI layer is formed from a solvent-soluble film precursor that is present in an electrolyte solution. Since the solvent-soluble film precursor is present in the electrolyte solution, the SEI layer may be formed in situ in the electrochemical cell. As used herein, the electrochemical cell may refer to the lithium sulfur battery, the lithium ion battery, the lithium metal battery, or a half cell or a Li—Li symmetrical cell with a working electrode and a counter/reference electrode. In a lithium sulfur battery, the SEI layer forms on the negative electrode, but not on the sulfur based positive electrode, in part because the sulfur dissolves in the electrolyte solution. In the lithium ion battery and the lithium metal battery, the SEI layer forms on both the negative electrode and the positive electrode. The half cell or the Li—Li symmetrical cell (with a working electrode and a counter/reference electrode) may be used to form the SEI layer on the negative electrode alone, and this negative electrode may then be incorporated into a full battery.

The solvent-soluble film precursors disclosed herein are capable of reacting with lithium. It is believed that a lithium negative electrode or a lithiated negative electrode (including an active material, such as silicon or graphite) and/or a lithium positive electrode is capable of providing the lithium source that reacts with the solvent-soluble film precursor. Due, in part, to the high reactivity of lithium, it is believed that the chemical reaction between the solvent-soluble film precursor(s) and the lithium may occur even in the absence of an applied voltage or load

Examples of the solvent-soluble film precursor include (Li₂S)₁—(P₂S₅)ₘ—(YX₂)ₙ, where Y is at least one of Ge, Si, Sn and where X is at least one of S, Se, Te. Each of 1, m and n≧0, but at least two of 1, m, or n is >0. In an example, each of 1, m and n is >0. Additionally, if Y is Ge, then GeX₂ is a zintl cluster with X being selected from the group consisting of S, Se, and Te. As examples, the solvent-soluble film precursor may be (Li₂S)—(P₂S₅)—(GeS₂) or Li₂S—P₂S₅. Further examples include Li₄SnS₄, Li₄SiS₄, Li₂S—SiS₂, and Li₄₋ₓSi₁₋ₓPₓS₄, where x is an integer in the range of 0 to 1, as well as other thio-lithium superionic conductors.

The solvent-soluble film precursor(s) is included in an electrolyte. The solvent-soluble film precursor may be included in any suitable amount. As an example, the solvent-soluble film precursor may be included in an amount ranging from about 1 wt % to about 10 wt % of a total wt % of the electrolyte. As other examples, the solvent-soluble film precursor may be included in an amount ranging from about 1 wt % to about 3 wt %, or from about 1 wt % to about 5 wt %, or from about 1 wt % to about 7 wt % of a total wt % of the electrolyte.

The electrolyte also includes a solvent and a lithium salt. The solvent selected is capable of dissolving the solvent-soluble film precursor(s). The selection of the electrolyte solvent may depend upon the type of electrochemical cell that is to be used to form the lithium conductive SEI layer in situ. When the lithium conductive SEI layer is to be formed in situ in a lithium sulfur battery, a lithium metal battery, or a Li—Li symmetrical cell, the electrolyte solvent may be selected from 1,3-dioxolane (DOL), dimethoxyethane (DME), tetrahydrofuran, 2-methyltetrahydrofuran, 1,2-diethoxyethane, ethoxymethoxyethane, tetraethylene glycol dimethyl ether (TEGDME), polyethylene glycol dimethyl ether (PEGDME), and mixtures thereof. When the SEI layer is to be formed in situ in a lithium ion battery, a lithium metal battery, or a Li—Li symmetrical cell, the electrolyte solvent may be selected from cyclic carbonates (ethylene carbonate (EC), propylene carbonate, butylene carbonate, fluoroethylene carbonate), linear carbonates (dimethyl carbonate (DMC), diethyl carbonate (DEC), ethylmethyl carbonate (EMC)), aliphatic carboxylic esters (methyl formate, methyl acetate, methyl propionate), γ-lactones (γ-butyrolactone, γ-valerolactone), chain structure ethers (1,2-dimethoxyethane, 1,2-diethoxyethane, ethoxymethoxyethane), cyclic ethers (tetrahydrofuran, 2-methyltetrahydrofuran), and mixtures thereof.

Examples of the lithium salt include LiClO₄, LiAlCl₄, LiI, LiBr, LiSCN, LiBF₄, LiB(C₆H₅)₄, LiAsF₆, LiCF₃SO₃, LiN(FSO₂)₂ (LIFSI), LiN(CF₃SO₂)₂ (LITFSI or lithium bis(trifluoromethylsulfonyl)imide), LiPF₆, LiB(C₂O₄)₂ (LiBOB), LiBF₂(C₂O₄) (LiODFB), LiPF₃(C₂F₅)₃ (LiFAP), LiPF₄(CF₃)₂, LiPF₄(C₂O₄) (LiFOP), LiPF₃(CF₃)₃, LiSO₃CF₃, LiNO₃, and mixtures thereof. The concentration of the lithium salt in the electrolyte ranges from about 0.1 mol/L to about 5 mol/L. In an example, the concentration of the salt in the electrolyte is about 1 mol/L.

Some examples of the electrolyte disclosed herein also include an organic sulfur-containing additive. The organic sulfur-containing additive may be included in any suitable amount. As an example, the organic sulfur-containing additive may be included in an amount ranging from about 1 wt % to about 10 wt % of a total wt % of the electrolyte.

The organic sulfur-containing additive may be an organosulfur, an organic sulfonate, an organic sultone, or combinations thereof. The organosulfur may have the formula: R—Sₘ—R′, where m≧2, and R and R′ are independently selected from one or more oxygen atoms, nitrogen atoms, fluorine atoms, and/or silicon atoms. R and R′ may be an aliphatic chain, an aromatic ring, a linear chain, a branched chain, a saturated chain, or an unsaturated chain. In an example, the organosulfur may be allyl disulfide. Suitable examples of the organic sulfonates and sultones include any of the following:

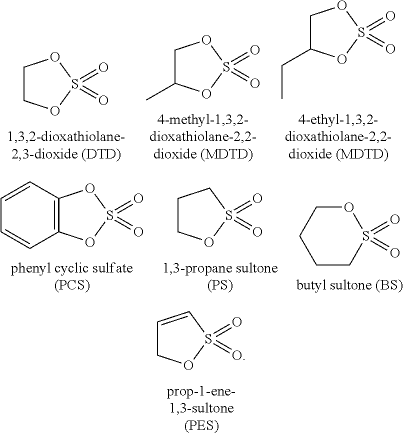

When included in the electrolyte, the organic sulfur-containing additive may be incorporated into the lithium conductive SEI layer, or may form an organic film on the lithium conductive SEI layer.

As mentioned above, the electrode upon which the lithium conductive SEI is formed will depend upon the electrochemical cell in which the electrolyte is being used. In each of the examples disclosed herein, the negative electrode has the SEI formed thereon. FIG. 1 illustrates an example of the negative electrode structure 10 resulting from the in situ formation of the lithium conductive SEI layer 14 on the negative electrode 12. FIG. 1 also illustrates that an organic film 16 may also be formed on the lithium conductive SEI layer 14. In any of the examples disclosed herein, the negative electrode 12 may include an active material, a binder material, and a conductive filler.

Examples of suitable active materials for the negative electrode 12 include any lithium host active material that can sufficiently undergo lithium intercalation and deintercalation, or lithium alloying and dealloying, or lithium insertion and deinsertion, while copper or another current collector functions as the negative terminal of the electrochemical cell. Examples of the lithium host active material include graphite, silicon-based materials, such as silicon alloys, or lithium-based materials. Further examples include tin, alloys of tin, antimony, and alloys of antimony. Graphite exhibits favorable lithium intercalation and deintercalation characteristics, is relatively non-reactive, and can store lithium in quantities that produce a relatively high energy density. Commercial forms of graphite that may be used to fabricate the negative electrode are available from, for example, Timcal Graphite & Carbon (Bodio, Switzerland), Lonza Group (Basel, Switzerland), or Superior Graphite (Chicago, Ill.). Examples of the silicon-based active material include crystalline silicon, amorphous silicon, silicon oxide (SiOₓ), silicon alloys (e.g., Si—Sn), etc. The silicon active material may be in the form of a powder, particles, etc. ranging from nano-size to micro-size. Examples of the lithium-based materials include lithium foil, lithium alloys, or lithium titanate. When lithium foil is used, the polymer binder and conductive filler may not be included in the negative electrode.

The binder material may be used to structurally hold the active material together. Examples of the binder material include polyvinylidene fluoride (PVdF), polyethylene oxide (PEO), an ethylene propylene diene monomer (EPDM) rubber, carboxymethyl cellulose (CMC), styrene-butadiene rubber (SBR), styrene-butadiene rubber carboxymethyl cellulose (SBR-CMC), polyacrylic acid (PAA), cross-linked polyacrylic acid-polyethylenimine, polyimide, or any other suitable binder material. Examples of the still other suitable binders include polyvinyl alcohol (PVA), sodium alginate, or other water-soluble binders.

The conductive filler material may be a conductive carbon material. The conductive carbon material may be a high surface area carbon, such as acetylene black or another carbon material (e.g., Super P). The conductive filler material is included to ensure electron conduction between the active material and the negative-side current collector in the battery.

The negative electrode 12 may include up to 90% by total weight (i.e., 90 wt %) of the active material and up to 20% by total weight (i.e., 20 wt %) of each of the conductive filler and binder material. In an example, the negative electrode 12 includes from about 70 wt % to about 90 wt % of the active material, from about 5 wt % to about 15 wt % of the conductive filler material, and from about 5 wt % to about 15 wt % of the binder material.

The negative electrode 12 may be purchased or formed. In an example, the negative electrode 12 may be formed by making a slurry of active material particles, binder material, and conductive filler material in water and/or a polar aprotic solvent (e.g., dimethylacetamide (DMAc), N-methyl-2-pyrrolidone (NMP), dimethylformamide (DMF), dimethylsulfoxide (DMSO), or another Lewis base, or combinations thereof).

The slurry may be mixed, and then deposited onto a support (not shown in FIG. 1). In an example, the support is a negative-side current collector. It is to be understood that the support may be formed from copper or any other appropriate electrically conductive material known to skilled artisans. The support that is selected should be capable of collecting and moving free electrons to and from an external circuit connected thereto. The slurry may be deposited using any suitable technique. As examples, the slurry may be cast on the surface of the support, or may be spread on the surface of the support, or may be coated on the surface of the support using a slot die coater.

The deposited slurry may be exposed to a drying process in order to remove any remaining solvent and/or water. Drying may be accomplished using any suitable technique. Drying may be performed at an elevated temperature ranging from about 60° C. to about 150° C. In some examples, vacuum may also be used to accelerate the drying process. As one example of the drying process, the deposited slurry may be exposed to vacuum at about 120° C. for about 12 to 24 hours. The drying process results in the formation of the negative electrode.

If the negative electrode 12 is not formed of lithium and is to be paired with a positive electrode that is also not formed of lithium, the negative electrode 12 may be exposed to a pre-lithiation process prior to incorporating it into the electrochemical cell/battery. The pre-lithiation technique lithiates the negative electrode 12. In an example, the negative electrode 12 may then be pre-lithiated using a half cell. More specifically, the half cell is assembled using the negative electrode 12, which is soaked in a suitable electrolyte, which includes a solvent and a lithium salt. The half cell includes a counter electrode, and a voltage potential is applied to the half cell. The application of the voltage causes lithium metal to penetrate the negative electrode 12. After pre-lithiation is complete, the half cell is disassembled and the pre-lithiated negative electrode may be washed using a suitable solvent, such as DME.

The negative electrode 12 (including lithium as the active material) or the pre-lithiated negative electrode (including graphite or a silicon-based active material) may then be used in an electrochemical cell/battery. The lithium conductive SEI layer will form on the negative electrode in situ (i.e., in the electrochemical cell). In general, the cell/battery may be assembled with the negative electrode 12, a suitable positive electrode (examples of which will be described below), a porous polymer separator positioned between the negative and positive electrodes, and an example of the electrolyte disclosed herein including a suitable solvent for the particular battery type.

Lithium Sulfur Battery/Electrochemical Cell

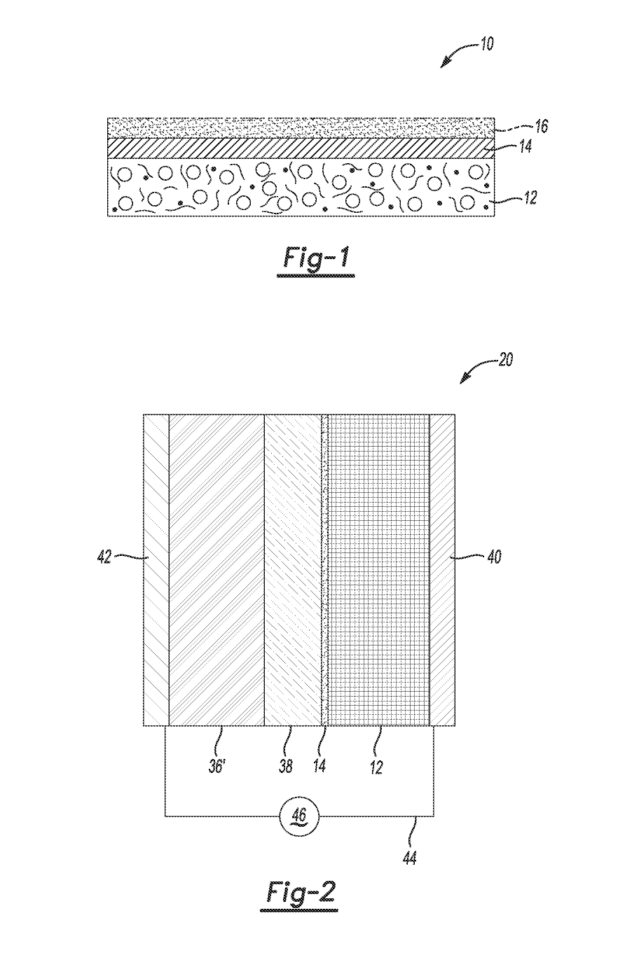

An example of a lithium sulfur battery 20 is shown in FIG. 2. For the lithium sulfur battery/electrochemical cell 20, any example of the negative electrode 12 (e.g., electrode with a lithium, silicon, or graphite active material) may be used. Other examples of active materials for the negative electrode include a lithium alloy, alloys of silicon, tin, alloys of tin, antimony, and alloys of antimony.

The positive electrode 36′ of the lithium sulfur battery includes any sulfur-based active material that can sufficiently undergo lithium alloying and dealloying with aluminum or another suitable current collector functioning as the positive terminal of the lithium sulfur electrochemical cell. An example of the sulfur-based active material is a sulfur-carbon composite. In an example, the weight ratio of S to C in the positive electrode ranges from 1:9 to 9:1. The positive electrode 36′ in the lithium sulfur battery 20 may include any of the previously mentioned binder materials and conductive fillers.

The porous polymer separator 38 may be formed, e.g., from a polyolefin. The polyolefin may be a homopolymer (derived from a single monomer constituent) or a heteropolymer (derived from more than one monomer constituent), and may be either linear or branched. If a heteropolymer derived from two monomer constituents is employed, the polyolefin may assume any copolymer chain arrangement including those of a block copolymer or a random copolymer. The same holds true if the polyolefin is a heteropolymer derived from more than two monomer constituents. As examples, the polyolefin may be polyethylene (PE), polypropylene (PP), a blend of PE and PP, or multi-layered structured porous films of PE and/or PP. Commercially available porous separators 16 include single layer polypropylene membranes, such as CELGARD 2400 and CELGARD 2500 from Celgard, LLC (Charlotte, N.C.). It is to be understood that the porous separator 38 may be coated or treated, or uncoated or untreated. For example, the porous separator 38 may or may not be coated or include any surfactant treatment thereon.

In other examples, the porous separator 38 may be formed from another polymer chosen from polyethylene terephthalate (PET), polyvinylidene fluoride (PVdF), polyamides (Nylons), polyurethanes, polycarbonates, polyesters, polyetheretherketones (PEEK), polyethersulfones (PES), polyimides (PI), polyamide-imides, polyethers, polyoxymethylene (e.g., acetal), polybutylene terephthalate, polyethylenenaphthenate, polybutene, polyolefin copolymers, acrylonitrile-butadiene styrene copolymers (ABS), polystyrene copolymers, polymethylmethacrylate (PMMA), polyvinyl chloride (PVC), polysiloxane polymers (such as polydimethylsiloxane (PDMS)), polybenzimidazole (PBI), polybenzoxazole (PBO), polyphenylenes (e.g., PARMAX™ (Mississippi Polymer Technologies, Inc., Bay Saint Louis, Miss.)), polyarylene ether ketones, polyperfluorocyclobutanes, polytetrafluoroethylene (PTFE), polyvinylidene fluoride copolymers and terpolymers, polyvinylidene chloride, polyvinylfluoride, liquid crystalline polymers (e.g., VECTRAN™ (Hoechst AG, Germany) and ZENITE® (DuPont, Wilmington, Del.)), polyaramides, polyphenylene oxide, and/or combinations thereof. It is believed that another example of a liquid crystalline polymer that may be used for the porous separator 38 is poly(p-hydroxybenzoic acid). In yet another example, the porous separator 38 may be chosen from a combination of the polyolefin (such as PE and/or PP) and one or more of the other polymers listed above.

The porous separator 38 may be a single layer or may be a multi-layer (e.g., bilayer, trilayer, etc.) laminate fabricated from either a dry or wet process. The porous separator operates as an electrical insulator (preventing the occurrence of a short), a mechanical support, and a barrier to prevent physical contact between the two electrodes. The porous separator also ensures passage of lithium ions (identified by the Li⁺) through the electrolyte filling its pores.

The negative electrode 12, sulfur based positive electrode 36′, and porous separator 38 are soaked with the electrolyte (not shown) disclosed herein, including the solvent-soluble film precursor, the lithium salt, the solvent suitable for the lithium sulfur battery 20, and in some instances, the organic sulfur-containing additive.

The lithium sulfur battery/electrochemical cell 20 also includes an external circuit 44 and a load 46. The application of the load 46 to the lithium sulfur electrochemical cell 20 closes the external circuit 44 and connects the negative electrode 12 and the positive electrode 36′. The closed external circuit enables a working voltage to be applied across the lithium sulfur electrochemical cell 20.

Upon the initial exposure of the negative electrode 12 to the electrolyte, the solvent-soluble film precursor may begin to react with lithium in the negative electrode 12 to form the lithium conductive SEI layer 14 on the surface of the negative electrode 12. A voltage potential may also be applied to the electrochemical cell/battery 20 in order to enhance the formation of the lithium conductive SEI layer 14. It is believed that the lithium in the negative electrode 12 reacts with the solvent-soluble film precursor (i.e., (Li₂S)₁—(P₂S₅)ₘ—(YX₂)ₙ). As a result of this reaction, lithiated (Li₂S)₁—(P₂S₅)ₘ—(YX₂)ₙ) may precipitate out of the electrolyte. These products may deposit on the surface of the negative electrode 12 to form the lithium conductive SEI layer 14. Other reactions may also or alternatively be taking place, and thus the lithium conductive SEI layer 14 may be formed of or include other reaction products. However, it is noted that the solvent-soluble film precursor (i.e., (Li₂S)₁—(P₂S₅)ₘ—(YX₂)ₙ) may suppress the formation of LiF in the SEI and may promote the polymerization of certain components of the electrolyte (e.g., 1,3-dioxolane). An SEI layer formed of the polymerization products may be more flexible and lithium ion conductive, as polyethylene oxide (PEO) can be formed. Without the additive, the dominant inorganic salt in SEI is LiF, which is not a lithium ion conductor. The additive(s) disclosed herein can form lithium ion conductors. A good SEI should be a good lithium ion conductor and electronically insulating. Therefore, the additive can improve the electrochemical performance of the batteries.

In an example when the organic sulfur-containing additive is included in the electrolyte, the lithium conductive SEI layer 14 that is formed on the negative electrode 12 in this example may include some organic reaction product, such as polypropylene, poly(ethylene oxide), and/or poly(mercaptopropyl)methylsiloxane. In another example, when the organic sulfur-containing additive is included in the electrolyte, the solvent-soluble film precursor may react first to form an inorganic lithium conductive SEI layer, and then the organic sulfur-containing additive may react to form an organic film (e.g., film 16 shown in FIG. 1) on the inorganic lithium conductive SEI layer 14.

As mentioned above, in the lithium sulfur battery 20, the sulfur in the positive electrode 36′ may dissolve in the electrolyte, rather than react with the solvent-soluble film precursor in the electrolyte. As such, the SEI layer 14 does not form on the surface of the positive electrode 26′ in the lithium sulfur battery 20.

Lithium Ion Battery/Electrochemical Cell

For the lithium ion battery/electrochemical cell (not shown), any example of the negative electrode (e.g., pre-lithiated negative electrode 12 with a silicon or graphite active material) may be used. Other examples of active materials for the negative electrode include a lithium alloy, alloys of silicon, tin, alloys of tin, antimony, and alloys of antimony. The lithium negative electrode may also be utilized in the lithium ion battery, for example, when the positive electrode is not a lithium based active material.

The positive electrode of the lithium ion battery includes any lithium-based or non-lithium-based active material that can sufficiently undergo lithium insertion and deinsertion with aluminum or another suitable current collector functioning as the positive terminal of the lithium ion electrochemical cell. One common class of known lithium-based active materials suitable for this example of the positive electrode includes layered lithium transition metal oxides. For example, the lithium-based active material may be spinel lithium manganese oxide (LiMn₂O₄), lithium cobalt oxide (LiCoO₂), a manganese-nickel oxide spinel [Li(Mn_{1.5}Ni_{0.5})O₂], or a layered nickel-manganese-cobalt oxide (having a general formula of xLi₂MnO₃.(1-x)LiMO₂ or (M is composed of any ratio of Ni, Mn and/or Co). A specific example of the layered nickel-manganese-cobalt oxide includes (xLi₂MnO₃.(1-x)Li(Ni_{1/3}Mn_{1/3}CO_{1/3})O₂). Other suitable lithium-based active materials include Li(Ni_{1/3}Mn_{1/3}CO_{1/3})O₂, Li_{x+y}Mn_{2-y}O₄ (LMO, 0<x<1 and 0<y<0.1), or a lithium iron polyanion oxide, such as lithium iron phosphate (LiFePO₄) or lithium iron fluorophosphate (Li₂FePO₄F), or a lithium rich layer-structure. Still other lithium-based active materials may also be utilized, such as LiNi₁₋ₓCo_{1-y}M_{x+y}O₂ or LiMn_{1.5-x}Ni_{0.5-y}M_{x+y}O₄ (M is composed of any ratio of Al, Ti, Cr, and/or Mg), stabilized lithium manganese oxide spinel (LiₓMn_{2-y}M_{y}O₄, where M is composed of any ratio of Al, Ti, Cr, and/or Mg), lithium nickel cobalt aluminum oxide (e.g., LiNi_{0.8} CO_{0.15}Al_{0.05}O₂) or NCA), aluminum stabilized lithium manganese oxide spinel (e.g., LiₓAl_{0.05}Mn_{0.95}O₂), lithium vanadium oxide (LiV₂O₅), Li₂MSiO₄ (where M is composed of any ratio of Co, Fe, and/or Mn), and any other high energy nickel-manganese-cobalt material (HE-NMC, NMC or LiNiMnCoO₂). By “any ratio” it is meant that any element may be present in any amount. So, in some examples, M could be Al, with or without Cr, Ti, and/or Mg, or any other combination of the listed elements. In another example, anion substitutions may be made in the lattice of any example of the lithium transition metal based active material to stabilize the crystal structure. For example, any O atom may be substituted with an F atom.

Suitable non-lithium based materials for this example of the positive electrode include metal oxides, such as manganese oxide (Mn₂O₄), cobalt oxide (CoO₂), a nickel-manganese oxide spinel, a layered nickel-manganese-cobalt oxide, or an iron polyanion oxide, such as iron phosphate (FePO₄) or iron fluorophosphate (FePO₄F), or vanadium oxide (V₂O₅).

The positive electrode in the lithium ion electrochemical cell/battery may include any of the previously mentioned binder materials and conductive fillers.

The lithium ion electrochemical cell/battery may also include any of the previously provided examples of the porous polymer separator.

The negative electrode, positive electrode, and porous separator are soaked with the electrolyte disclosed herein, including the solvent-soluble film precursor, the lithium salt, the solvent suitable for the lithium ion battery, and in some instances, the organic sulfur-containing additive.

The lithium ion battery/electrochemical cell also includes an external circuit and a load. The application of the load to the lithium ion electrochemical cell closes the external circuit and connects the negative electrode and the positive electrode. The closed external circuit enables a working voltage to be applied across the lithium ion electrochemical cell.

Upon the initial exposure of the negative electrode to the electrolyte, the solvent-soluble film precursor may begin to react with lithium in the negative electrode and lithium or other metal(s). A voltage potential may also be applied to the electrochemical cell/battery in order to enhance the formation of the lithium conductive SEI layers. It is believed that the lithium in the negative electrode and lithium or other metal in the positive electrode reacts with the solvent-soluble film precursor (i.e., (Li₂S)₁—(P₂S₅)ₘ—(YX₂)ₙ). As a result of these reactions, lithiated (Li₂S)₁—(P₂S₅)ₘ—(YX₂)ₙ may precipitate out of the electrolyte. These products may deposit on the surface of the negative and positive electrodes to form the respective lithium conductive SEI layers. Other reactions may also or alternatively be taking place, and thus the lithium conductive SEI layer may be formed of or include other reaction products. As previously mentioned, the solvent-soluble film precursor (i.e., (Li₂S)₁—(P₂S₅)ₘ—(YX₂)ₙ) may suppress the formation of LiF and may promote the polymerization of certain components of the electrolyte (e.g., 1,3-dioxolane).

In an example when the organic sulfur-containing additive is included in the electrolyte, the lithium conductive SEI layers that are formed may include some organic reaction product (e.g., polypropylene, poly(ethylene oxide), poly(mercaptopropyl)methylsiloxane, etc.). In another example, when the organic sulfur-containing additive is included in the electrolyte, the solvent-soluble film precursor may react first to form an inorganic lithium conductive SEI layer, and then the organic sulfur-containing additive may react to form an organic film on the inorganic lithium conductive SEI layer.

Lithium Metal Battery/Electrochemical Cell

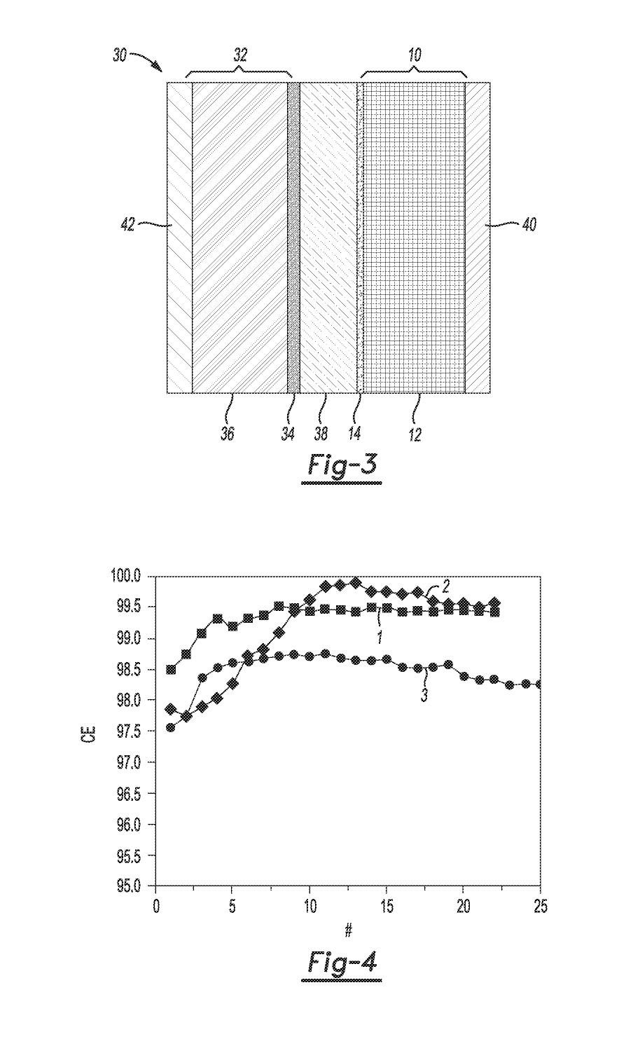

An example of a lithium metal battery 30 is shown in FIG. 3. More particularly, FIG. 3 illustrates an example of the lithium metal battery 30 having a negative electrode structure 10 resulting from the in situ formation of the lithium conductive SEI layer 14 on the negative electrode 12 as well as a positive electrode structure 32 resulting from the in situ formation of the lithium conductive SEI layer 34 on the positive electrode 36. In these cases, the negative electrode 12 is lithium or lithium-alloy, and the positive electrode 36 includes a lithium-based active material. Any of the previous lithium-based active materials may be used in the lithium metal battery 30, an example of which includes LiFePO₄. The negative electrode 12 and/or positive electrode 36 in the lithium metal battery 30 may include any of the previously described conductive fillers and/or binders. However, when lithium foil is utilized, such additives may not be included.

FIG. 3 also illustrates that the porous separator 38 may also be positioned between the electrode structures 10, 32. Metal contacts may be made to the electrodes 12, 36, such as an aluminum contact 40 to negative electrode 12 and a copper contact 42 to positive electrode 36.

The same considerations described above for the formation of the SEI layer on the negative electrode 12 and positive electrode 36 apply in the lithium metal battery 30. The lithium conductive SEI layers 14, 34 disclosed herein are each a protective coating in that an SEI layer 14 protects the negative electrode 12 from additional reactions with the electrolyte and another SEI layer 34 protects the positive electrode 36 from additional reactions with the electrolyte. The lithium conductive SEI layers 14, 34 also exhibit uniformity (in composition and thickness), and adhesion to the negative electrode 12 and the positive electrode 36.

Li—Li Symmetrical Cells

A Li—Li symmetrical cell (not shown) may be used to form the SEI on the negative electrode 12 before it is incorporated into a full electrochemical cell. For the Li—Li symmetrical electrochemical cell, the negative electrode 12 (or counter electrode) is formed of lithium metal.

The positive electrode of the Li—Li symmetrical cell may include a copper working electrode plated with lithium (e.g., 1 mAh Li onto the copper).

The lithium-lithium symmetrical electrochemical cell may also include any of the previously provided examples of the porous polymer separator.

The negative electrode, positive electrode, and porous separator are soaked with the electrolyte disclosed herein, including the additive, the lithium salt, the solvent suitable for the lithium-lithium symmetrical electrochemical cell, and in some instances, the organic sulfur-containing additive.

The lithium-lithium symmetrical electrochemical cell also includes an external circuit and a load. The application of the load to the lithium-lithium symmetrical electrochemical cell closes the external circuit and connects the negative electrode and the positive electrode. The closed external circuit enables a working voltage to be applied across the lithium-lithium symmetrical electrochemical cell.

Upon the initial exposure of the negative electrode to the electrolyte, the solvent-soluble film precursor may begin to react with the lithium metal negative electrode to form the lithium conductive SEI layer on the surface of the negative electrode. A voltage potential may also be applied to the electrochemical cell in order to enhance the formation of the lithium conductive SEI layer. Voltage may be applied on the negative electrode (e.g., a charging cycle), in order to force the reaction to happen between the additive in the electrolyte and the negative electrode. It is believed that the lithium in the negative electrode reacts with the solvent-soluble film precursor (i.e., (Li₂S)₁—(P₂S₅)ₘ—(YX₂)ₙ). As a result of this reaction, lithiated (Li₂S)₁—(P₂S₅)ₘ—(YX₂)ₙ may precipitate out of the electrolyte. These products may deposit on the surface of the negative electrode to form the lithium conductive SEI layer. Other reactions may also or alternatively be taking place, and thus the lithium conductive SEI layer may be formed of or include other reaction products.

In an example when the organic sulfur-containing additive is included in the electrolyte, the lithium conductive SEI layer that is formed may include some organic reaction product (e.g., polypropylene, poly(ethylene oxide), poly(mercaptopropyl)methylsiloxane, etc.). In another example, when the organic sulfur-containing additive is included in the electrolyte, the solvent-soluble film precursor may react first to form an inorganic lithium conductive SEI layer, and then the organic sulfur-containing additive may react to form an organic film on the inorganic lithium conductive SEI layer.

It is to be understood that the negative electrode structure (i.e., lithium metal electrode with the SEI layer thereon) formed in situ in the lithium-lithium symmetrical electrochemical cell may be rinsed and incorporated as the negative electrode in another lithium metal based battery.

In any of the examples disclosed herein, the voltage potential that is applied may range from about −2V to about 3V.

The lithium conductive SEI layer disclosed herein is a protective coating in that it protects the negative electrode or the negative electrode and the positive electrode from additional reactions with the electrolyte. The lithium conductive SEI layer also exhibits uniformity (in composition and thickness), and adhesion to the negative electrode.

To further illustrate the present disclosure, examples are given herein. It is to be understood that these examples are provided for illustrative purposes and are not to be construed as limiting the scope of the present disclosure.

### Example 1

A first example electrochemical cell was formulated with copper as a working electrode and lithium as a counter electrode. The electrolyte of the first example electrochemical cell included 0.4M LiTFSI and 0.6M LiNO₃ in DOL/DME (1:1 vol ratio) and 1 wt % of Li₂S—P₂S₅.

A second example electrochemical cell was formulated with copper as a working electrode and lithium as a counter electrode. The electrolyte of the second example electrochemical cell included 0.4M LiTFSI and 0.6M LiNO₃ in DOL/DME (1:1 vol ratio), 1 wt % of Li₂S—P₂S₅, and 1 wt % of allyldisulfide.

A first comparative electrochemical cell was formulated with copper as a working electrode and lithium as a counter electrode. The electrolyte in the first comparative cell included 0.4M LiTFSI and 0.6M LiNO₃ in DOL/DME (1:1 vol ratio) (without any solvent-soluble film precursor or organic sulfur-containing additive).

The test conditions for the comparative and example cells were: room temperature; current=250 μA; area=1.23 cm²; and voltage cutoff ranging from −2V to 2V. The Coulombic efficiency results are shown in FIG. 4. In FIG. 4, the Y axis, labeled CE, represents the Coulombic efficiency (percentage) and the X axis, labeled “#,” represents the cycle number. As illustrated in FIG. 4, throughout the cycles, the Coulombic efficiency of the first example cell (labeled “1”) with the solvent-soluble film precursor in the electrolyte was generally higher than the Coulombic efficiency of the comparative cell (labeled “3”). Also as illustrated in FIG. 4, after 5 cycles, the Coulombic efficiency of the second example cell (labeled “2”) with the solvent-soluble film precursor and the organic sulfur-containing additive in the electrolyte was higher than the Coulombic efficiency of the comparative cell (labeled “3”).

### Example 2

A third example electrochemical cell was formulated with lithium as the negative electrode and LiFePO₄ as the positive electrode. The electrolyte of the third example electrochemical cell included 0.4M LiTFSI and 0.6M LiNO₃ in DOL/DME (1:1 vol ratio) and 1 wt % of Li₂S—P₂S₅ as the additive.

A fourth example electrochemical cell was formulated with lithium as the negative electrode and LiFePO₄ as the positive electrode. The electrolyte of the fourth example electrochemical cell included 0.4M LiTFSI and 0.6M LiNO₃ in DOL/DME (1:1 vol ratio), 3 wt % of Li₂S—P₂S₅ as the additive.

A second comparative electrochemical cell was formulated with lithium as the negative electrode and LiFePO₄ as the positive electrode. The electrolyte in the second comparative cell included 0.4M LiTFSI and 0.6M LiNO₃ in DOL/DME (1:1 vol ratio) (without any additive).

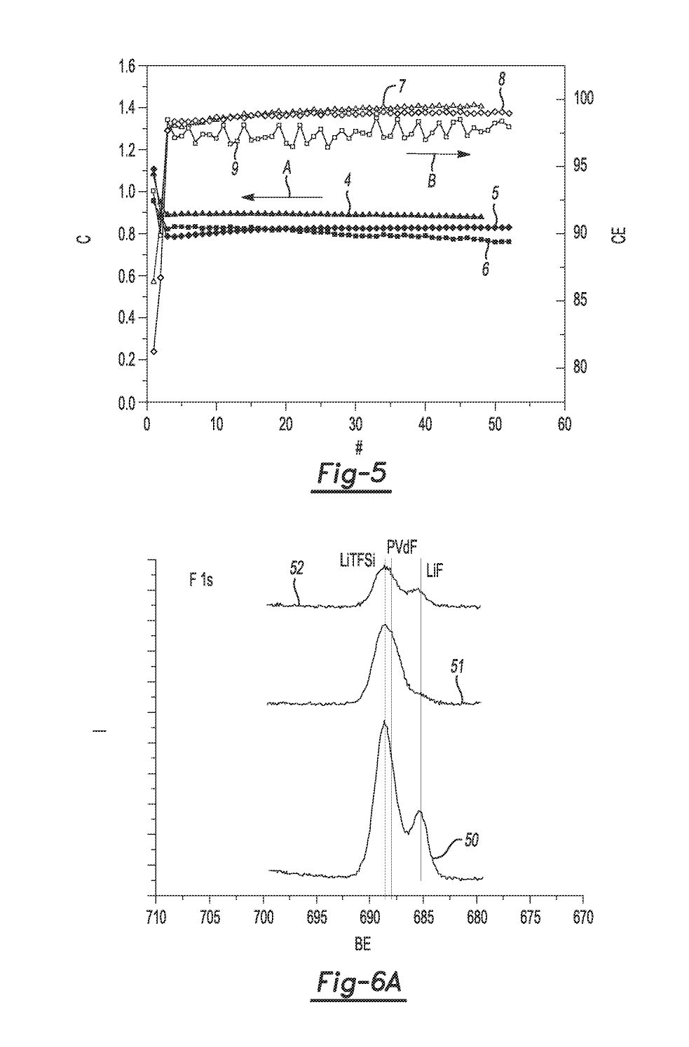

The test conditions for the comparative and example cells were: room temperature; current=50 μA; area=1.23 cm²; and voltage cutoff ranging from −3.0 V to 3.7 V. The capacity retention results are shown in FIG. 5, along with the Coulombic efficiency results. In FIG. 5, the left Y axis, labeled C, represents the capacity retention (in mAh), the right Y axis, labeled CE, represents the Coulombic efficiency (in percentage), and the X axis, labeled “#,” represents the cycle number. The lower set of curves, 4-6, relate to the capacity retention, as indicated by arrow “A”. The upper set of curves, 7-9, relate to the Coulombic efficiency, as indicated by arrow “B”.

As illustrated in FIG. 5, throughout the cycles, the capacity retention of the third example cell (labeled “4”) with 1% additive in the electrolyte was generally higher than the capacity retention of the second comparative cell (labeled “6”). Also as illustrated in FIG. 5, the capacity retention of the fourth example cell (labeled “5”) with 3% additive in the electrolyte was higher than the capacity retention of the second comparative cell (labeled “6”) after about 15 cycles, although not as high as the third example cell (1% additive).

As illustrated in FIG. 5, throughout the cycles, the Coulombic efficiency of the third example cell (labeled “7”) with 1% additive in the electrolyte was generally higher than the Coulombic efficiency of the second comparative cell (labeled “9”). Also as illustrated in FIG. 5, after 5 cycles, the Coulombic efficiency of the fourth example cell (labeled “8”) with 3% additive in the electrolyte was higher than the Coulombic efficiency of the second comparative cell (labeled “9”).

From FIG. 5, it can be seen that the additive improves battery performance such as capacity retention and Coulombic efficiency. The efficiency can be improved from 97% to above 99.5% in the Li—LiFePO₄ cell.

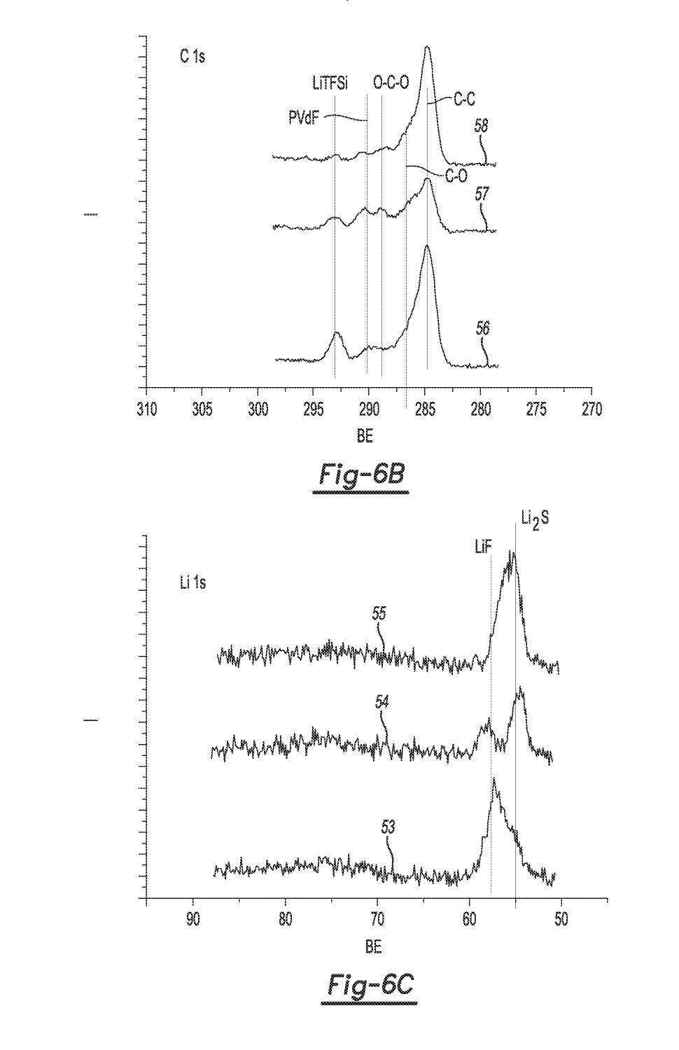

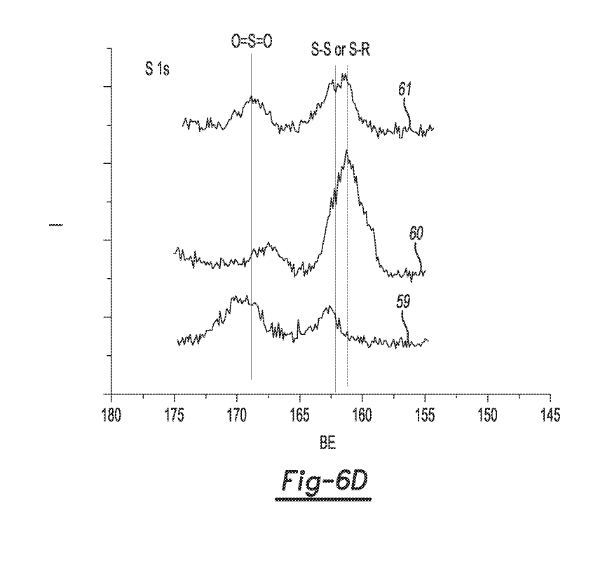

FIGS. 6A-6D illustrate the X-ray photoelectron spectroscopy (XPS) results, employing the foregoing electrolyte and additive. Each plot shows the results for third and fourth example electrochemical cell and for the second comparative electrochemical cell.

In FIG. 6A, which measured the F 1s electron in the positive electrode/cathode SEI 34, the second comparative electrochemical cell (Curve 50) reveals the presence of C—F due to LiTFSi or PVdF. In comparing Curves 51 and 52 with Curve 50, the amount of LiF 1s reduced in the third and fourth electrochemical cells compared to the amount in the second comparative cell.

In FIG. 6C, which measured the Li 1s electron in the negative electrode/anode SEI 14, the second comparative electrochemical cell (Curve 53) reveals the presence of LiF and Li₂S. The third example electrochemical cell (Curve 54) reveals the presence of LiF and Li₂S, but not as much LiF as the second comparative electrochemical cell and more Li₂S than the second comparative electrochemical cell. The fourth example electrochemical cell (Curve 55) reveals essentially no LiF and the presence of even more Li₂S than the third example electrochemical cell.

In FIG. 6B, which measured the C 1s electron in the positive electrode/cathode SEI 34, the second comparative electrochemical cell (Curve 56) reveals the presence of LiTFSi, PVdF, and the C—C bond. If the O—C—O group is present, it is in relatively small amount, while the C—O bond appears to be absent. The third example electrochemical cell (Curve 57) reveals the presence of LiTFSi (though not as much as the second comparative electrochemical cell), PVdF, the O—C—O group, apparently a relatively amount of the C—O bond, and the C—C bond. The fourth example electrochemical cell (Curve 58) reveals the presence of the C—C bond. The amounts of LiTFSi, PVdF, the O—C—O group, and the C—O bond, if present, are at relatively small amounts.

In FIG. 6D, which measured the S 1s electron in the negative electrode/anode SEI 14, the second comparative electrochemical cell (Curve 59) reveals the presence of the O═S═O group; the S—R bond appears to be absent or, if present, in a relatively small amount. The third example electrochemical cell (Curve 60) reveals the presence of the O═S═O group and the S—R bond. The S—S bond may be present, but is masked by the S—R bond. The fourth example electrochemical cell (Curve 61) reveals the presence of the O═S═O group, as well as the S—S bond and the S—R bond. These results indicate the presence of S—S or S—R species in the SEI after the addition of the additives.

The foregoing XPS results indicate that the additives suppress the LiF formation in the SEI and may promote the polymerization of 1,3-dioxolane.

It is to be understood that the ranges provided herein include the stated range and any value or sub-range within the stated range. For example, a range of from 1:9 to 9:1 should be interpreted to include not only the explicitly recited limits of from 1:9 to 9:1, but also to include individual values, such as 1:2, 7:1, etc., and sub-ranges, such as from about 1:3 to 6:3 (i.e., 2:1), etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. An electrolyte, comprising:
a solvent;
a lithium salt; and
a solvent-soluble film precursor selected from the group consisting of (Li₂S)₁—(P₂S₅)ₘ—(YX₂)ₙ wherein each of 1, m and n≧0 but at least two of 1, m, or n is >0, Y is at least one element selected from the group consisting of Ge, Si, and Sn, and X is at least one element selected from the group consisting of S, Se, and Te.

2. The electrolyte as defined in claim 1 wherein:
where Y═Ge, then GeX₂ is a zintl cluster with X being selected from the group consisting of S, Se, and Te.

3. The electrolyte as defined in claim 1, further comprising an organic sulfur-containing additive selected from the group consisting of an organosulfur, an organic sulfonate, an organic sultone, and combinations thereof.

4. The electrolyte as defined in claim 1 wherein:
the solvent is selected from the group consisting of 1,3-dioxolane, dimethoxyethane, tetrahydrofuran, 2-methyltetrahydrofuran, 1,2-diethoxyethane, ethoxymethoxyethane, tetraethylene glycol dimethyl ether (TEGDME), polyethylene glycol dimethyl ether (PEGDME), and mixtures thereof; and
the lithium salt is selected from the group consisting of lithium bis(trifluoromethylsulfonyl)imide (LiN(CF₃SO₂)₂ or LiTFSI), LiNO₃, LiPF₆, LiBF₄, LiI, LiBr, LiSCN, LiClO₄, LiAlCl₄, LiB(C₂O₄)₂ (LiBOB), LiB(C₆H₅)₄, LiBF₂(C₂O₄) (LiODFB), LiN(SO₂F)₂ (LiFSI), LiPF₃(C₂F₅)₃ (LiFAP), LiPF₄(CF₃)₂, LiPF₄(C₂O₄) (LiFOP), LiPF₃(CF₃)₃, LiSO₃CF₃, LiCF₃SO₃, LiAsF₆, and combinations thereof.

5. The electrolyte as defined in claim 1 wherein:
the solvent is selected from the group consisting of ethylene carbonate, propylene carbonate, butylene carbonate, fluoroethylene carbonate, dimethyl carbonate, diethyl carbonate, ethylmethyl carbonate, methyl formate, methyl acetate, methyl propionate, γ-butyrolactone, γ-valerolactone, 1,2-dimethoxyethane, 1,2-diethoxyethane, ethoxymethoxyethane, and combinations thereof; and
the lithium salt is selected from the group consisting of lithium bis(trifluoromethylsulfonyl)imide (LiN(CF₃SO₂)₂ or LiTFSI), LiNO₃, LiPF₆, LiBF₄, LiI, LiBr, LiSCN, LiClO₄, LiAlCl₄, LiB(C₂O₄)₂ (LiBOB), LiB(C₆H₅)₄, LiBF₂(C₂O₄) (LiODFB), LiN(SO₂F)₂ (LiFSI), LiPF₃(C₂F₅)₃ (LiFAP), LiPF₄(CF₃)₂, LiPF₄(C₂O₄) (LiFOP), LiPF₃(CF₃)₃, LiSO₃CF₃, LiCF₃SO₃, LiAsF₆, and combinations thereof.

6. An electrode structure, comprising:
an electrode including an active material; and
a lithium conductive solid electrolyte interface (SEI) layer formed on a surface of the electrode, the lithium conductive SEI layer formed from a film precursor selected from the group consisting of (Li₂S)₁—(P₂S₅)ₘ—(YX₂)ₙ wherein each of 1, m and n≧0 but at least two of 1, m, or n is >0, Y is at least one element selected from the group consisting of Ge, Si, and Sn, and X is at least one element selected from the group consisting of S, Se, and Te.

7. The electrode structure as defined in claim 6 wherein:
where Y═Ge, then GeX₂ is a zintl cluster with X being selected from the group consisting of S, Se, and Te.

8. The electrode structure as defined in claim 6 wherein the lithium conductive SEI layer further includes an organic sulfur-containing additive selected from the group consisting of an organosulfur, an organic sulfonate, an organic sultone, and combinations thereof.

9. The electrode structure as defined in claim 6, further comprising an organic film formed on the lithium conductive SEI layer, the organic film including an organic sulfur-containing component selected from the group consisting of an organosulfur, an organic sulfonate, an organic sultone, and combinations thereof.

10. A method for making a lithium conductive solid electrolyte interface (SEI) layer on a surface of an electrode, the method comprising:
exposing the electrode to an electrolyte in an electrochemical cell, the electrolyte including:
a solvent;
a lithium salt; and
a solvent-soluble film precursor selected from the group consisting of (Li₂S)₁—(P₂S₅)ₘ—(YX₂)ₙ wherein each of 1, m and n≧0 but at least two of 1, m, or n is >0, Y is at least one element selected from the group consisting of Ge, Si, and Sn, and X is at least one element selected from the group consisting of S, Se, and Te.

11. The method as defined in claim 10 wherein:
where Y═Ge, then GeX₂ is a zintl cluster with X being selected from the group consisting of S, Se, and Te.

12. The method as defined in claim 10, further comprising applying a voltage to the electrochemical cell.

13. The method as defined in claim 10, further comprising pre-lithiating the electrode prior to exposing the electrode to the electrolyte.

14. The method as defined in claim 10 wherein:
the electrode is a negative electrode;
the electrochemical cell is a full battery cell including a positive electrode; and
the method further comprises exposing the positive electrode to the electrolyte, thereby forming a second lithium conductive solid electrolyte interface (SEI) layer on a surface of the positive electrode.

15. A lithium-based battery, comprising:
a negative electrode;
a positive electrode;
a separator positioned between the negative electrode and the positive electrode; and
an electrolyte solution soaking each of the positive electrode, the negative electrode, and the separator, wherein the electrolyte solution includes:
a solvent;
a lithium salt; and
a solvent-soluble film precursor selected from the group consisting (Li₂S)₁—(P₂S₅)ₘ—(YX₂)ₙ, wherein each of 1, m and n≧0 but at least two of 1, m, or n is >0, Y is at least one element selected from the group consisting of Ge, Si, and Sn, and X is at least one element selected from the group consisting of S, Se, and Te.

16. The lithium-based battery as defined in claim 15 wherein:
where Y═Ge, then GeX₂ is a zintl cluster with X being selected from the group consisting of S, Se, and Te.

17. The lithium-based battery as defined in claim 15 wherein:
the negative electrode includes an active material selected from the group consisting of lithium, a lithium alloy, silicon, alloys of silicon, graphite, tin, alloys of tin, antimony, and alloys of antimony; and
the positive electrode includes a sulfur based active material.

18. The lithium-based battery as defined in claim 17, further including a lithium conductive solid electrolyte interface (SEI) layer formed on a surface of the negative electrode, the lithium conductive SEI layer formed from the solvent-soluble film precursor.

19. The lithium-based battery as defined in claim 15 wherein:
the negative electrode includes an active material selected from the group consisting of lithium, lithium alloy, silicon, alloys of silicon, graphite, tin, alloys of tin, antimony, and alloys of antimony; and
the positive electrode includes an active material selected from the group consisting of a lithium based material and a non-lithium metal oxide material.

20. The lithium-based battery as defined in claim 19, further including a first lithium conductive solid electrolyte interface (SEI) layer formed on a surface of the negative electrode, the first lithium conductive SEI layer formed from the solvent-soluble film precursor, and further including a second lithium conductive solid electrolyte interface (SEI) layer formed on a surface of the positive electrode, the second lithium conductive SEI layer formed from the solvent-soluble film precursor.
